(19) United States
(12) Patent Application Publication
(10) Pub. No.: US 2003/0107199 A1
(43) Pub. Date: Jun. 12, 2003

(54) Board with rollers for descending hills

(76) Inventor: Eric G. DeSchinkel, Chatham (CA)

Correspondence Address: SMART AND BIGGAR, 438 UNIVERSITY AVENUE, SUITE 1500 BOX 111, TORONTO, ON, M5G2K8, CA

(21) Appl. No.: 10/005,331

(22) Filed: Dec. 7, 2001

(51) Int. Cl. B62M 1/00

(52) U.S. Cl. 280/87.042

(57) ABSTRACT

A roller board which emulates the characteristics of a winter snow board has three rollers located under the platform. The suspension for the forward roller has a track projecting downwardly and forwardly from the board for guiding the axles of this roller and the rearward roller has a track projecting downwardly and rearwardly from the board for guiding the axles of the rearward roller. In consequence, when a rider leans to one side of the board such that the ends of the rollers at that side ride up into their suspensions, the forward and rearward rollers turn from their transverse rest positions. This assists in improving the turning characteristics of the board.

### BACKGROUND OF THE INVENTION

1. Field of the Invention

This invention relates to a board with rollers which can be used on hills with soft or grassy terrain.

2. Description of the Related Art

Snowboarding has become increasingly popular and is quickly emerging as a full-fledged competitive winter sport with acrobatic exhibitions and artistic performances. Accordingly, snowboards now account for a significant portion of traffic on the slopes at ski resorts. As the sport evolves however, efforts have been directed towards expanding its field of practice, which until now has been substantially limited to snow covered slopes. Snowboard athletes and enthusiasts require warm weather training aids to allow them the opportunity to practice for their sport all year around. Thus, a need has appeared for dry land snowboards that can faithfully reproduce the sensation of riding on a snowboard while being used on terrain with an irregular topography, not unlike a snowboarding slope.

As is well understood, snowboards turn primarily by “edging”. When a rider leans his weight towards the intended direction of travel, the snowboard leans onto its edge and turns an arc equivalent to the board's edge. This is made possible by the presence of sidecuts in the board and flex in the board design.

U.S. Pat. No. 5,855,385, issued Jan. 5, 1999 to Hambsch, describes a wheeled board device that has a platform with concave sides. Primary wheels are located along a central longitudinal axis of the platform and outrigger wheels are located along the concave sides. While perhaps functional on a paved surface, this wheeled board device would be undermined by dirt and grass if it were used on rough hill terrain. Further, turning might prove difficult with this device.

### SUMMARY OF THE INVENTION

This invention seeks to provide roller boards which can simulate the turning characteristics of a snowboard.

The present invention provides a board with rollers comprising: a platform for supporting a rider; a forward roller located under a forward portion of said platform; a forward roller suspension supporting each end of said forward roller such that as a given end of said forward roller rides up in one said forward roller suspension toward said platform, said given end of said forward roller moves rearwardly with respect to said platform whereby to facilitate steering of said platform.

According to another aspect of the present invention, there is provided a roller board comprising: a platform for supporting a rider; a forward roller located under a forward portion of said platform; a pair of tracks projecting from an underside of said platform downwardly and forwardly with respect to said platform, either end of said forward roller received by one of said pair of tracks for movement along said one track.

According to a further aspect of the present invention, there is provided 14. A board with rollers, comprising: a platform for supporting a rider; a forward roller located under a forward portion of said platform; a rearward roller located under a rearward portion of said platform; suspension means for each of said forward roller and said rearward roller for turning said forward roller in one sense from a transverse rest position to a turned position and said rearward roller in an opposite sense from a transverse rest position to a turned position when a greater weight is applied to one side of said platform than to the other side of said platform.

### BRIEF DESCRIPTION OF THE DRAWINGS

The present invention will be further understood from the following description with references to the drawings in which:

FIG. 1 is a perspective view of a board with rollers for descending hills in accordance with an embodiment of the present invention;

FIG. 2 is a side elevation view of the board shown in FIG. 1;

FIG. 3 is a bottom view of the board shown in FIG. 1;

FIG. 4a is a cross-sectional front view of a suspension used with the board of FIG. 1;

FIGS. 4b and 4c are side, and bottom views, respectively, of the suspension of FIG. 4a; and

FIG. 5 is a schematic bottom view of the board of FIG. 1 resulting when a greater weight is applied to one side of the board.

### DETAILED DESCRIPTION OF THE PREFERRED EMBODIMENTS

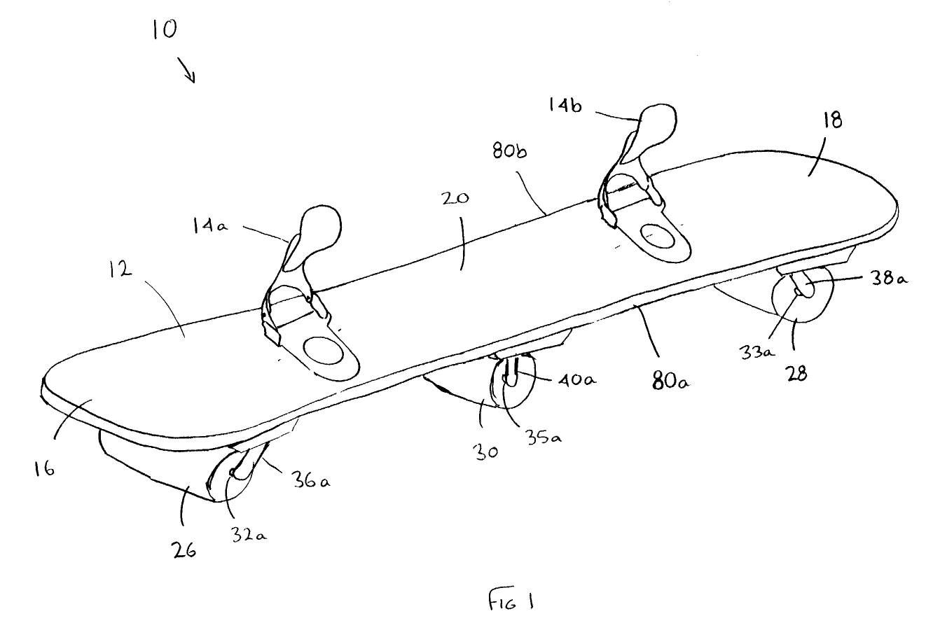

Turning to FIG. 1, a board with rollers 10 has a platform 12 with two foot retainers 14a and 14b for supporting a rider. As it is conventional for snow boards, a forward portion 16 and a rearward portion 18 of the platform 12 is wider than a middle portion 20 of the platform.

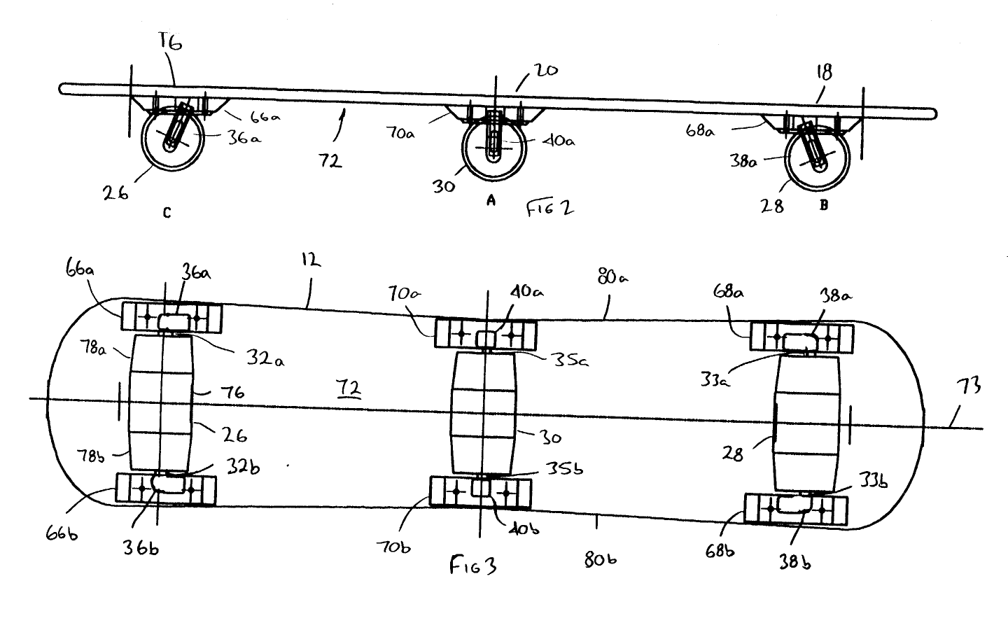

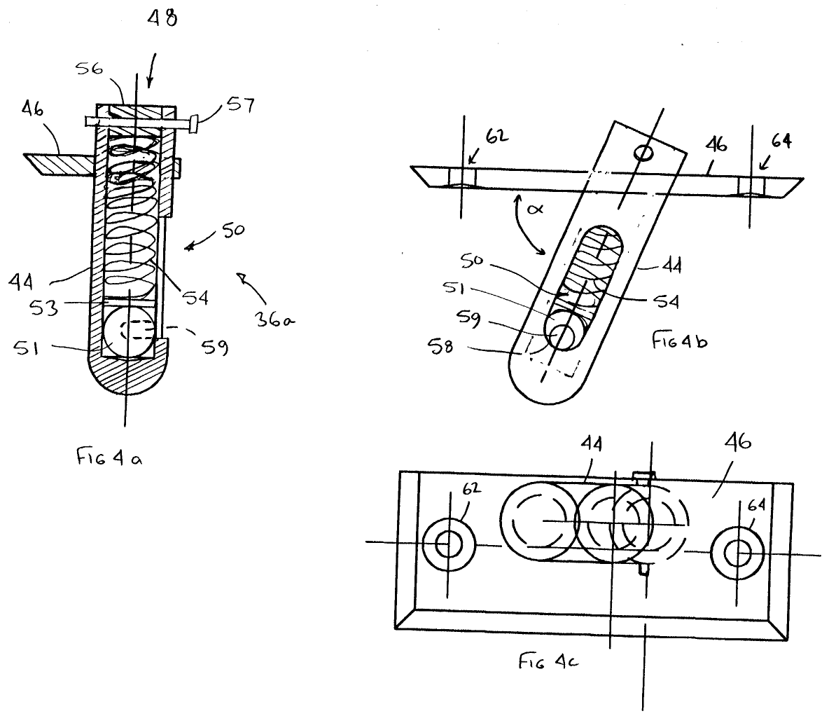

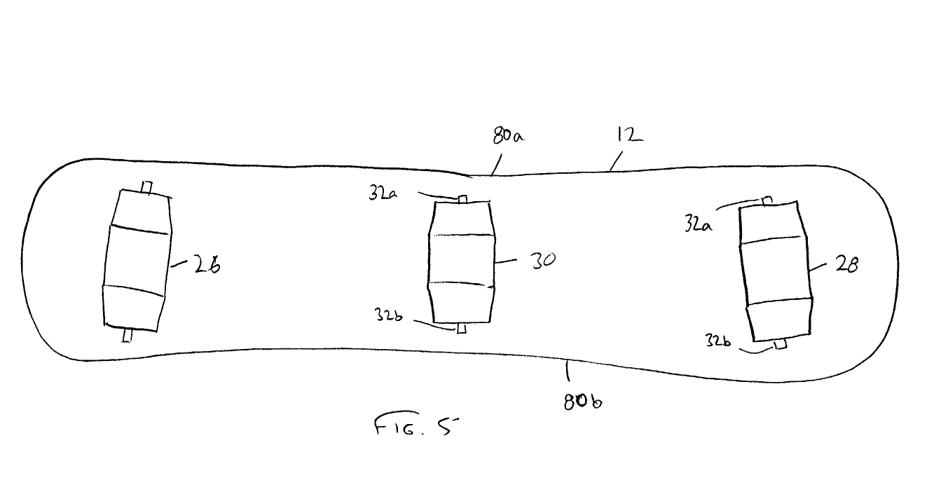

Turning to FIGS. 2 and 3 along with FIG. 1, a forward roller 26 is located under forward portion 16 at platform 12, a rearward roller 28 is located under rearward portion 18 of the platform and a medial roller 30 is located under the middle portion 20 of the platform. The three rollers of board 10 are positioned one behind the next so as to extend across longitudinal centre line 73 of the board. In a rest position illustrated in FIG. 3, each roller extends transversely of the platfrom 12. Each roller has an axle projecting from either end which is received by a suspension. Thus, axles 32a, 32b of forward roller 26 are supported by suspensions 36a, 36b, respectively; axles 33a, 33b of rearward roller 18 are supported by suspensions 38a, 38b, respectively, and axles 35a, 35b of medial roller 30 are supported by suspensions 40a, 40b, respectively. Suspension 36a is detailed in FIGS. 4a, 4b, and 4c. Turning to these figures, this suspension comprises a finger 44 attached to a plate 46. The finger 44 has a blind bore 48 extending from its upper end. The finger also has an elongate transverse through channel 50. The blind bore receives, in consecutive order from its bottom end, brass ball 51, nylon washer 53, spring 54, and plug 56. The plug 56 is retained in the open end of the blind bore by a pin 57. The ball 51 has a blind bore 59. Axle 32a (FIG. 3) of roller 26 is received through channel 50 of finger 44 and the blind bore 59 of the ball 51. With the spring 54 captured in bore 48 and supporting axle 32a (FIG. 3) of roller 26, the spring applies a restoring force to the axle and, therefore that end of the roller, urging the axle toward the bottom end 58 of channel 50. The finger projects downwardly and forwardly with respect to plate 46 making an angle, α, with the plate of between about 65° and 70°. The plate 46 is provided with countersunk holes 62, 64 which allow the plate to be mounted to the underside of platform 12 (FIGS. 1, 2, 3).

Suspension 36b is identical to suspension 36a. Furthermore, suspension 38a and 38b are also identical to suspension 36a except that they are turned 180° with respect to suspension 36a. Thus, each of suspensions 36a and 36b projects downwardly and rearwardly of the plate rather than downwardly and forwardly. Suspensions 40a and 40b are identical to suspension 36a except that the finger of suspensions 40a and 40b is mounted so as to project perpendicularly with respect to the plate.

As seen in FIGS. 2 and 3, the platform 12 has mounting blocks 66a, 66b, 68a, 68b, and 70a, 70b projecting from its under-surface 72. Each of the suspensions is mounted to one of these mounting blocks with screws (not shown) which are received by the bores 62, 64 of the suspensions. In this regard, it should be noted that each of the mounting blocks has a lower surface which parallels the under-surface 72 of the platform 12. In consequence, the fingers 44 of suspensions 36a, 36b, 38a, 38b will each be angled with respect to the under-surface 72 of the platform at the aforenoted angle α. Further, the same angle α may also be measured with respect to the longitudinal centre line 73 of platform 12 which parallels the under-surface 72 of the platform. While, as aforenoted, α may be between 65° and 70°, it is preferred that it be about 67½°.

Roller 26 has a cylindrical medial portion 76 and frusto-conical end portions 78a, 78b each having a rolling surface making approximately a 5° angle with the rolling surface of the cylindrical medial portion 76. Rollers 28 and 30 are similarly configured. Roller 30 is shorter than rollers 26 and 28.

Finger 44 and plate 46 may be forged as a single integral element.

In operation, a prospective rider may secure his feet to platform 12 by way of foot retainers 14a, 14b. When the board is under way and the rider leans to one side of the board, the ends of the rollers at that side of the board ride up into their suspensions to a greater degree than at the opposite end of each roller due to the weight differential applied by the rider. If, for example, the rider tilts over toward side 80a of the platform, then axle 32a of roller 26 will ride further into suspension 36a than will axle 32b of roller 26 ride into its suspension 36b. In consequence, axle 32a will be drawn further rearwardly of the platform 12 than will axle 32b. This will result in the forward roller turning from its transverse rest position shown in FIG. 3 to a turned position illustrated in FIG. 5. At the same time, the axle 33a of the rearward roller 28 moves further into its suspension than does axle 33b of roller 28 ride into its suspension. In consequence, the portion of roller 28 extending from axle 33a is drawn forwardly of platform 12 in comparison with the portion of the roller extending from axle 33b. The result is that roller 28 turns from its transverse rest position illustrated in FIG. 3 to a turned position illustrated in FIG. 5. Because the fingers of suspensions 40a and 40b are at right angles to their mounting plates, and hence to under-surface 72 of the platform 12, roller 30 remains positioned transversely of platform 12 despite the fact that axle 35a of roller 30 rides further into its suspension 40a than does axle 35b rides into its suspension 40b. Thus, as illustrated in FIG. 5, roller 30 maintains its transverse orientation with respect to platform 12. It will therefore be apparent that by a rider leaning to side 80a, the rollers turn so as to facilitate turning in the direction of side 80a. The same effect results when the rider leans toward side 80b to facilitate steering toward that side of platform 12.

Where a rider does not lean to either side, the suspensions 36a, 36b, 33a, 33b, 35a, 35b perform the conventional role of absorbing bumps.

The frusto-concial end portions of each roller provide a taper at either end portion of each roller resulting in a greater surface area of ground contact while turning. At the same time, this taper reduces rolling friction when the board in not tilted toward either side 80a, 80b. Because mounting blocks 66a, 66b, 60a, 60b, 70a and 70b extend from the ends of the rollers, a rider may tilt platform 12 to bottom out on these mounting blocks to brake the board 10.

The angle, a, chosen will depend upon desired turning characteristics of the board.

While each suspension has been described as a finger with a channel, any suitable alternative suspension may be used. For example, each axle could have a bulbous end which is retained by a track running along an inside face of the finger. Also, the finger of the suspension could be replaced by any other track support, such as a triangular support.

Optionally, the rollers could be cylindrical rather than having frusto-conical end portions. While the board has been described as having three rollers, it could equally have a larger number such as four or six rollers. However, a larger number of rollers increases the weight of the board and rolling friction. Thus, in many instances, a small number of rollers is preferred.

Where there are more than three rollers, any medial roller between the forward roller 26 and rearward roller 28 may maintain its transverse orientation despite a rider leaning to one side of the board. Alternatively, any medial roller (other than a medial roller is at the midway point of the platform 12) could turn with a leaning rider in a similar fashion to rollers 26 and 28. In such case, the degree to which the suspensions turn such medial rollers may be the same as, or less than, the degree to which the forward and rearward rollers 26, 28 are turned by their suspensions. In other words, the angle which the channels of the suspensions make with the longitudinal centre line 73 of platform 12 may be the same as, or less than, the angle made by the channels of the forward and rearward rollers 26, 28.

Other modifications will be apparent to those skilled in the art and, therefore, the invention is defined in the claims.

What is claimed is:

1. A board with rollers comprising:
a platform for supporting a rider;
a forward roller located under a forward portion of said platform;
a forward roller suspension supporting each end of said forward roller such that as a given end of said forward roller rides up in one said forward roller suspension toward said platform, said given end of said forward roller moves rearwardly with respect to said platform whereby to facilitate steering of said platform.

2. The board of claim 1 further comprising:
a rearward roller located under a rearward portion of said platform;
a rearward roller suspension supporting each end of said rearward roller such that as a given end of said rearward roller rides up in one said rearward roller suspension toward said platform, said given end of said rearward roller moves forwardly with respect to said platform.

3. The board of claim 2 further comprising:
at least one medial roller located under a medial portion of said platform between said forward roller and said rearward roller;
for each medial roller, a medial suspension supporting each end of said each medial roller such that as a given end of said each medial roller rides up in one said medial suspension toward said platform, said given end of said each medial roller moves neither forwardly nor rearwardly with respect to said platform.

4. The board of claim 3 wherein said at least one medial roller comprises one medial roller located at an elongate midpoint of said platform.

5. The board of claim 3 further comprising a foot retainer for each foot of a user disposed above said platform.

6. The board of claim 5 wherein each said suspension comprises a finger with a channel receiving an axle projecting from said given end of one said roller so as to define relative movement of said given end of said one said roller with respect to said platform.

7. The board of claim 6 further comprising a spring to bias said axle, and therefore said given end of said one said roller, toward an outer end of said channel.

8. The board of claim 7 wherein each of said at least one medial roller is shorter than said forward roller and than said rearward roller.

9. The board of claim 6 wherein said channel is linear and makes an angle of between 65 and 70 degrees with a longitudinal axis of said platform.

10. The board of claim 9 wherein each said roller has a cylindrical medial portion and a frusto-conical end portion having a rolling surface making approximately a 5 degree angle with a rolling surface of said cylindrical medial portion.

11. A roller board comprising:
a platform for supporting a rider;
a forward roller located under a forward portion of said platform;
a pair of tracks projecting from an underside of said platform downwardly and forwardly with respect to said platform, either end of said forward roller received by one of said pair of tracks for movement along said one track.

12. The roller board of claim 11 wherein each of said pair of tracks comprises a channel in a finger supported under said platform and wherein said forward roller comprises an axle received by each said channel.

13. The roller board of claim 12 further comprising biasing means to bias either end of said forward roller toward a bottom end of said pair of tracks.

14. A board with rollers, comprising:
a platform for supporting a rider;
a forward roller located under a forward portion of said platform;
a rearward roller located under a rearward portion of said platform;
suspension means for each of said forward roller and said rearward roller for turning said forward roller in one sense from a transverse rest position to a turned position and said rearward roller in an opposite sense from a transverse rest position to a turned position when a greater weight is applied to one side of said platform than to the other side of said platform.

15. The roller board of claim 14 further comprising at least one medial roller between said forward roller and said rearward roller and suspension means for each of said at least one medial roller for maintaining said at least one medial roller in a transverse orientation when a greater weight is applied to one side of said platform than to the other side of said platform.
